(19) United States
(12) Patent Application Publication
(10) Pub. No.: US 2018/0263417 A1
(43) Pub. Date: Sep. 20, 2018

(54) Food Press with Adjustable legs

(71) Applicant: KEVIN W. METHENY, West Lafayette, IN (US)

(72) Inventor: KEVIN W. METHENY, West Lafayette, IN (US)

(21) Appl. No.: 15/914,430

(22) Filed: Mar. 7, 2018

Related U.S. Application Data
(60) Provisional application No. 62/601,159, filed on Mar. 14, 2017.

(51) Int. Cl. A47J 37/10; A47J 43/18

(52) U.S. Cl. CPC A47J 37/108; A47J 43/18

(57) ABSTRACT

This invention relates to a device and method for cooking bacon. The Bacon Press with adjustable legs is comprised of a steel plate threaded with adjustable legs so that the user can control the distance between the plate and the cooking surface. The plate may be in various shapes. The plate may contain holes for viewing food while cooking.

### CROSS-REFERENCE TO RELATED APPLICATIONS

This application claims the priority of U.S. provisional patent application Ser. No. 62/601,159 filed on Mar. 14, 2017, and incorporates the subject matter thereof in its entirety.

### FIELD

This invention relates to a device and method for cooking bacon.

### BACKGROUND

Bacon has a tendency to curl up when it is being fried in a flat pan or griddle because of its high fat content. The use of a bacon press has been employed by individuals and restaurants for centuries to counteract this problem and yield flatter and more uniformed cooked bacon.

Bacon composition varies in protein and fat content. The variance in bacon composition often results in unevenly cooked bacon. Other cooking parameters may also vary, such as heating source and type of griddle or pan. The typical consumer may find it difficult to consistently prepare bacon given the variance in starting product and cooking conditions.

Bacon presses have existed for centuries in many forms as a plate to flatten or hold flat strips of cut bacon while frying. These plates have been made from stone, wood, plastic, ferrous and non-ferrous metals with a handle to isolate the plate from a person's hand as the plate can become quite hot. Some presses have legs of varying heights and this would control the amount of flatness or curl of the bacon during the frying operation. Applicant is not aware of a bacon press including adjustable legs.

U.S. Pat. No. 2,513,839 A, by Clay T. Barnes, teaches a bacon cooking aid consisting of a plate and handle. The plate is preferably of aluminum or stainless steel. The plate will flex under application of the weight to the handle and will apply pressure to the bacon and flatten the bacon against the bottom of the pan and against itself. The '839 teaches that no turning is required, and complete cooking can be effected. The '839 does not disclose plate legs that can vary in height.

Canadian Patent Application Publication No. 2044823 A1 teaches a device used in the cooking of sliced meat such as bacon. A flat weight is placed on top of the meat during cooking to hold it flat and also to hold the meat against the cooking surface. The device has a flat heat resistant surface with a heat resistant handle. The device may or may not be heated. The '823 does not disclose legs for the flat weight.

U.S. Pat. No. 2,579,258 A, by Frederick W. Heckert, teaches a grill and spatula assembly for cooking bacon and eggs simultaneously. A portion of the bacon grease is used to cook the eggs. Excess bacon grease is poured off as the spatula is used to press the bacon to the grill and keep the bacon in place. The '258 does not disclose legs for the spatula.

U.S. Pat. No. 8,926,302 B1, by Christina Buckley, discloses an adjustable food press for making a wide variety of hot and cold sandwiches and other foods that are compressed during preparation. The food press is used in conjunction with a griddle or fry pan to cook bacon. The user places the food on the flat cooking surface, places the dome over the food to create a seal, sets the desired height on the handle assembly, and then presses the food to the desired height with the handle. The '302 does not disclose adjusting the height of the press.

U.S. Patent Application Publication No. 20160270594 A1 discloses a device for cooking food articles. The device uses a hard lid placed directly on top of the food article. The lid applies pressure on the food and a cooking surface beneath through mechanical means. The lid can be adjusted to vary the pressure. The '594 does not disclose adjusting the height of the lid.

There is a need in the art for an effective means to adjust the height of a bacon press to meet the individual requirements for cooking/frying of bacon.

### SUMMARY

In one aspect of the invention, the Bacon Press with adjustable legs is a modified bacon press that features adjustable legs.

The design for the Bacon Press with adjustable legs utilizes a flat steel plate with holes in it to let the consumer see their bacon while cooking it. The plate has threaded holes for the legs to support the press at a specific height set by the consumer.

In a further aspect of the invention, the Bacon Press is comprised of a steel plate threaded with adjustable legs. The steel plate has holes to allow the user to view bacon while cooking.

In additional aspects of the invention, the steel plate shape is round, oval, rectangular, square, or animal. The animal shape may be cow, pig, fish, or any other.

In additional aspects of the invention, there are four adjustable legs. In other aspects of the invention there are at least three legs. In other aspects of the invention there are more than four legs.

In another aspect of the invention the Bacon Press is comprised of a steel plate that is coated in ceramic.

In additional aspects of the invention, the Bacon Press further comprises a handle.

In additional aspects of the invention, the Bacon Press further comprises a screen.

### BRIEF DESCRIPTION OF THE DRAWINGS

The above-mentioned and other features of this disclosure, and the manner of attaining them, will become more apparent and the disclosure itself will be better understood by reference to the following description of embodiments of the disclosure taken in conjunction with the accompanying drawings, wherein:

FIG. 1 illustrates a perspective view of the Bacon Press with adjustable legs.

FIG. 2 illustrates an exploded view of the Bacon Press with adjustable legs.

FIG. 3 illustrates a close-up view of an adjustable leg and a threaded hole of the Bacon Press with adjustable legs.

FIG. 4 illustrates a top view of the Bacon Press with adjustable legs.

FIG. 5 illustrates a bottom view of the Bacon Press with adjustable legs.

FIG. 6 illustrates a perspective view of an alternative embodiment of the Bacon Press with adjustable legs.

Corresponding reference characters indicate corresponding parts throughout the several views. Although the drawings represent embodiments of the present disclosure, the drawings are not necessarily to scale and certain features may be exaggerated in order to better illustrate and explain the present disclosure.

### DETAILED DESCRIPTION OF THE EXEMPLARY EMBODIMENTS

The embodiments disclosed below are not intended to be exhaustive or limit the disclosure to the precise forms disclosed in the following detailed description. Rather, the embodiments are chosen and described so that others skilled in the art may utilize their teachings.

One aspect of the invention is a device for cooking bacon. The Bacon Press with adjustable legs permits the chef or consumer to control the desired consistency of bacon during the frying process. The Bacon Press with adjustable legs allows the user to control the consistency of bacon in an efficient manner.

The appealing features of the Bacon Press with adjustable legs are: an adjustable height design, time-savings, energy-savings, convenience, efficiency, durability, reasonable price, ease of use, and novel design.

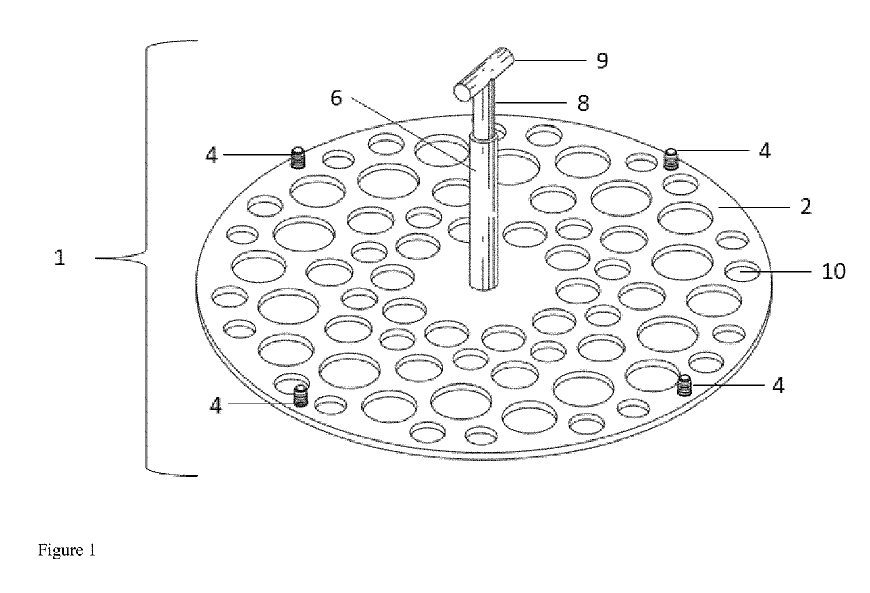

As illustrated in FIG. 1, the Bacon Press 1 with adjustable legs 4 utilizes a flat steel plate 2 with apertures 10 to allow the user to view bacon during the cooking process. The center of the plate features a 304 stainless steel drawer pull/handle comprised of a threaded handle portion 7, a lower vertical handle portion 6, an upper vertical handle portion 8 and a horizontal handle portion 9. The exemplary embodiment features four adjustable legs 4.

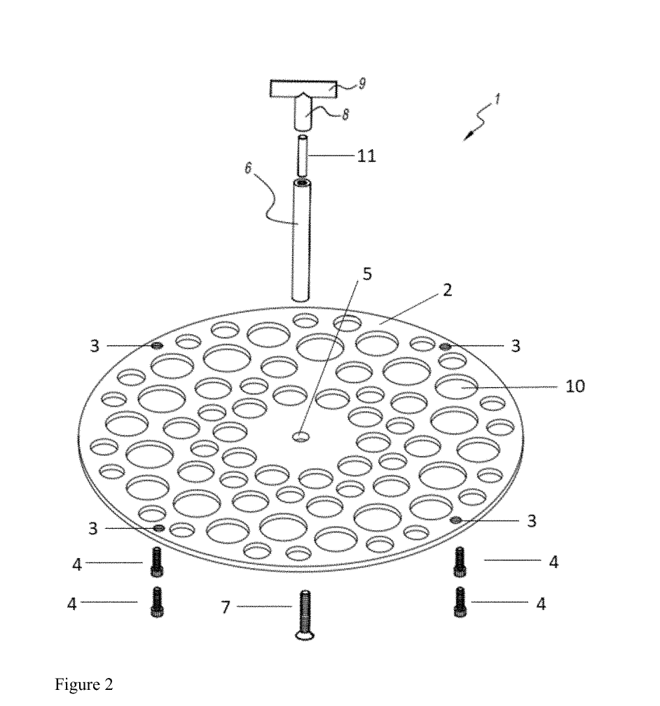

As illustrated in FIG. 2, the plate 2 features threaded holes 3 for the legs 4 to support the press at a specific height set by the user. The plate 2 also features a threaded hole 5 that receives the threaded handle portion 7.

In the exemplary embodiment, threaded handle portion 7 is a zinc plated flat head cap screw, 10-32×1″. Lower vertical handle portion 6 is a stainless steel handle stem that is threaded on both ends 1″ deep, 10-32×1″. Upper vertical handle portion 8 and horizontal handle portion 9 is a threaded T shaped stainless steel handle, 10-32×1″. A 10-32 zinc plated steel coupler 11 is used to connect handle stem 6 to the T-shaped handle formed by 8 & 9. Cap screw 7 is screwed into the bottom of handle stem 6.

The user may select a low leg height for extremely flat, crisp bacon. The user may select a high leg height for bacon with a balance of well-cooked to a floppy/rippled consistency. The user may also select everything in between low and high leg height for the complete range of bacon frying conditions.

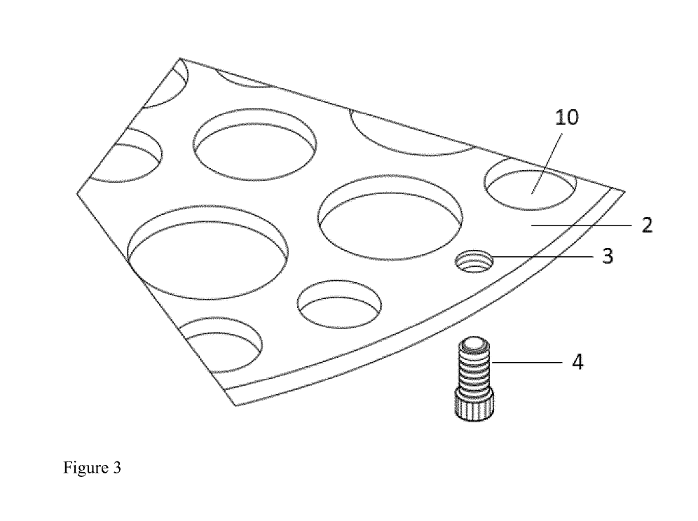

As illustrated in FIG. 3, the steel plate 2 has threaded holes 3 configured to receive the adjustable leg 4.

The plate 2 features a grill surface comprised of a 12-gauge steel or steel that is 0.125 inch thick. The steel may be coated in ceramic. The aforementioned steel provides a better thickness of material for threading the material. And it has more weight to hold down the bacon while frying, which can be extremely springy during the frying process.

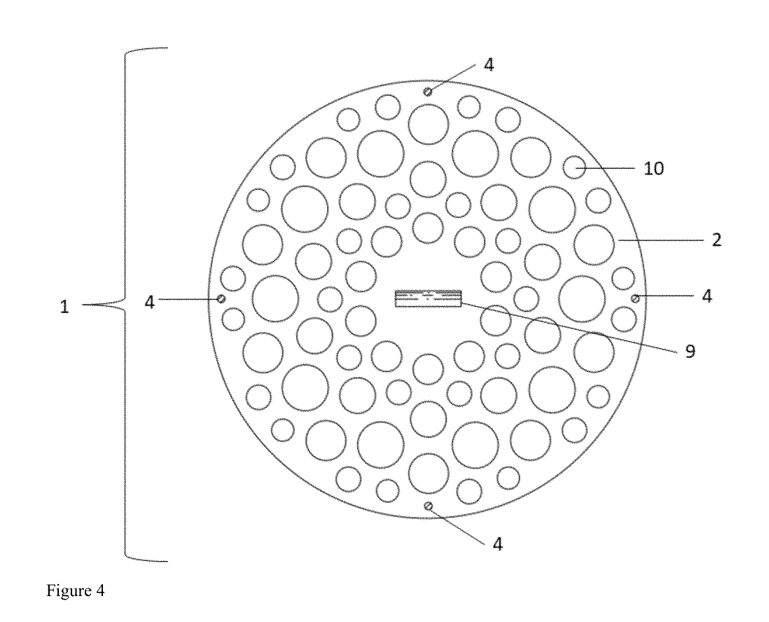

As illustrated in FIG. 4, in the top down view of the Bacon Press 1 with adjustable legs 4. The only visible portion of the handle is horizontal handle portion 9, located in the center of steel plate 2.

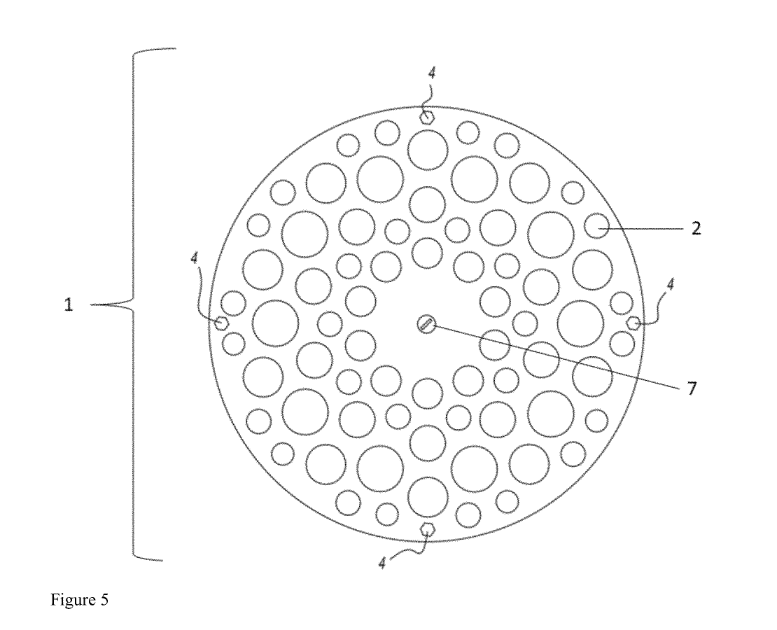

As illustrated in FIG. 5, in the bottom view of the Bacon Press 1 with adjustable legs 4, the steel plate 2 has four 10-32 socket head cap screws 4 that permit leg height adjustment. These screws 4 may define typical flat head, phillips head, or socket head configurations and be adjusted with fingers, screw drivers, an allen wrench, or other means.

It is also envisioned that the screws 4 may be oriented with the head configurations on top of the plate 2 to aid a user in adjusting the screws 4 while using the bacon press 1. It is also envisioned that the screws 4 may be mounted with a steel or other heat resistant handle to allow for a user to adjust the screws 4 with fingers while using the bacon press 1.

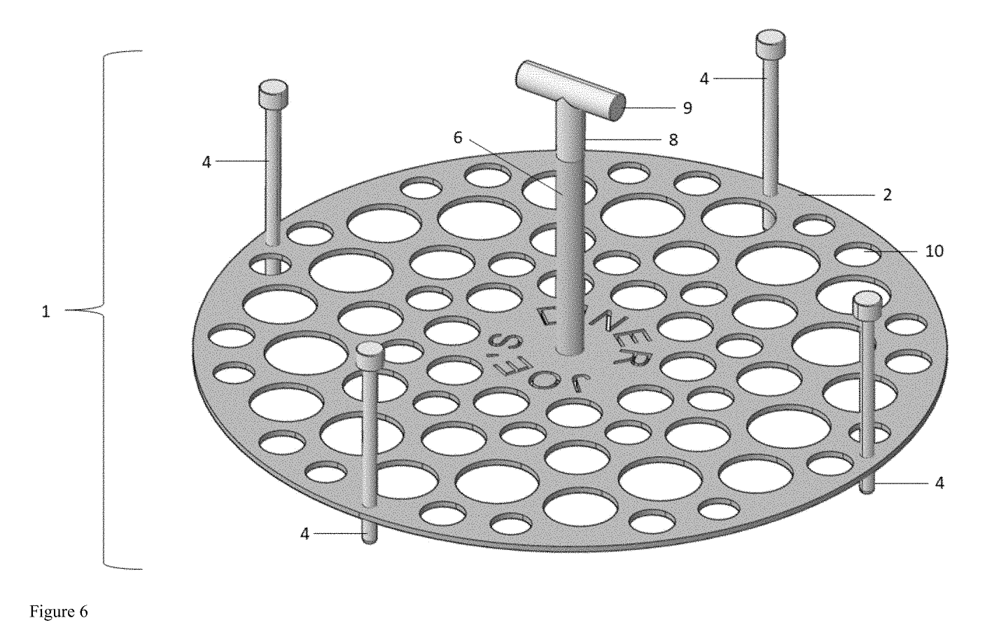

As illustrated in FIG. 6, in alternative embodiment of the Bacon Press 1 with adjustable legs, screws 4 oriented with the head configurations on top of the plate 2 to aid a user in adjusting the screws 4 while using the bacon press 1. Screws 4 are longer and are mounted with a steel or other heat resistant handle to allow for a user to adjust the screws 4 with fingers while using the bacon press 1 and to facilitate further height adjustment for cooking other types of food.

The plate 2 may be produced in a plethora of shapes, including but not limited to round, oval, square, rectangular, pig-shaped, cow-shaped, and fish-shaped version. In one embodiment the rectangular version measures 8 by 12 inches. In another embodiment, the round version is 10 inches in diameter and 4 inches high.

Other things can also be cooked in the bacon press 1, such as searing other meats (chipped meat or patties), vegetables, or dumplings. Cooking presses 1 can be used in other capacities such as steaming, roasting, or broiling.

In another embodiment the device is printed with various names and/or logos.

In another embodiment, Bacon Press with adjustable legs includes additional legs.

In another embodiment, Bacon Press with adjustable legs is comprised of steel with other thickness.

In another embodiment, Bacon Press with adjustable legs includes a solid handle running across the plate.

In another embodiment, Bacon Press with adjustable legs is comprised of a rolled edge for steaming.

In another embodiment, Bacon Press with adjustable legs is further comprised of a screen.

The screen may be the same shapes as the plate. The screen has an aperture in the center that is the same shape and slightly larger than horizontal handle component 9.

Another aspect of the invention is a method of cooking bacon using the Bacon Press with adjustable legs. The Bacon Press with adjustable legs is placed over bacon in a hot frying pan and allowed to cook on each side. In one embodiment, the method is to allow the bacon to cook for one minute on the first side and for two minutes on the second side.

In another aspect of the method is placing a screen over the horizontal handle component 9 and lowering it to rest on the edge of the pan or on top of the steel plate.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

What is claimed is:

1. A cooking device comprised of
a steel plate defining threaded holes configured to receive screws, wherein the steel plate defines apertures to allow the user to view bacon while cooking, wherein the screws are adjustable legs, and
a 304 stainless steel drawer handle configured to mount to a threaded hole in the steel plate.

2. The cooking device of claim 1, wherein the steel plate is 12-gauge steel or steel that is 0.125 inch thick.

3. The cooking device of claim 1, wherein the steel plate shape is round, oval, rectangular, square, or animal.

4. The cooking device of claim 3, wherein the animal shape is cow, pig, or fish.

5. The cooking device of claim 1, wherein there are at least three adjustable legs.

6. The cooking device of claim 5, wherein there are four adjustable legs.

7. The cooking device of claim 1, wherein the steel plate is coated in ceramic.

8. The cooking device of claim 1, wherein the handle minimizes heat transfer from the plate.

9. The cooking device of claim 1, further comprising a screen.
